(19) United States
(12) Patent Application Publication
(10) Pub. No.: US 2014/0234458 A1
(43) Pub. Date: Aug. 21, 2014

(54) Device for manufacturing components from fiber-reinforced composites

(71) Applicant: Faserverbund Innovations UG (haftungsbeschränkt), Ibbenburen (DE)

(72) Inventor: Dominik Dierkes, Ibbenburen (DE)

(73) Assignee: Faserverbund Innovations UG (haftungsbeschränkt), Ibbenburen (DE)

(21) Appl. No.: 14/180,375

(22) Filed: Feb. 14, 2014

(30) Foreign Application Priority Data
Feb. 15, 2013 (DE) 10 2013 002 551.6

(51) Int. Cl. B29C 70/54; B29C 33/00

(52) U.S. Cl. CPC B29C 70/546; B29C 33/00
USPC 425/146; 425/145

(57) ABSTRACT

A device for producing fiber-reinforced composites has a mold with an airtightly closed mold chamber for forming a composite of fiber material and matrix material. A membrane in the mold separates fiber and matrix material from a gas suction passage. A suction connector is connected to the mold and sucks gas out of the mold chamber via the gas suction passage. The matrix material flows from the resin container into the mold chamber through an inflow connector. A sensor provided on the inflow connector or the resin connector and connected to the actuator measures actual pressure existing in the inflow connector or the resin connector. An actuator is connected to the closure element and moves the closure element, when activated by a trigger signal emitted by the sensor, from an open into a closed position so that the closure element closes off the inflow connector or the resin container.

### BACKGROUND OF THE INVENTION

The invention relates to a device for manufacturing components from fiber-reinforced composites. The device comprises a mold that comprises an air-tightly closeable mold chamber for receiving and forming a composite of a fiber material and a matrix material. Into the mold, a membrane element for separating the fiber material and the matrix material from a gas suction passage can be inserted. The device further comprises a suction connector for removing by suction the gas that is contained in the mold chamber, wherein the suction connector is connected with the mold by means of the gas suction passage. The device further comprises an inflow connector for a matrix material that is to be introduced from a resin container into the mold chamber.

A device of the aforementioned kind is disclosed, for example, in U.S. Pat. No. 6,843,953. A device and a method are described wherein, by applying a vacuum to a mold, a matrix material is sucked from a resin container into the mold chamber and the matrix material spreads uniformly within the mold chamber across a gas-permeable but matrix material-impermeable membrane provided as a blocking membrane until the matrix material fills the entire cavity of the mold chamber and the fiber material is wetted and impregnated. The blocking membrane separates the matrix material from the gas suction passages so that the gas suction passages cannot become clogged with the matrix material and remain available up to the point of termination of the filling process of the mold chamber for the purpose of sucking away the gas that is contained in the mold chamber. When the mold chamber is covered across the entire surface area with the membrane, the vacuum can act across the entire covered surface area. When filling of the mold chamber is completed, the matrix material can cure or harden. After sufficient curing, the finished component can be removed from the mold chamber.

An alternative technique for separating the matrix material from the gas suction passages in a device for producing components of fiber-reinforced composites is disclosed in DE 20 2010 001 836.6. In this document the membrane element is in the form of a hose-type gas suction line which is disposed in the interior of the impregnation mold and is enveloped with a gas-permeable but matrix material-impermeable membrane so that the matrix material, when vacuum is applied to the gas suction line, can spread within the mold chamber but cannot penetrate into the gas suction line. The mold chamber cannot be completely covered across its surface area with the gas suction line or lines that are enveloped by the membrane; however, this is not necessary because with a suitable arrangement of the gas suction lines in the mold chamber or within the rim area of the mold chamber a vacuum-induced complete filling of the mold chamber with the matrix material can be achieved.

In the two aforementioned devices, the mold chamber constitutes an impregnation tool in which the fiber material placed into the mold chamber is impregnated with the matrix material so that after curing of the matrix material a fiber-reinforced composite component is produced. Fiber-reinforced composite components are characterized by high strength and load resistance while tending to usually have a low density (specific weight). As a fiber material, for example, mats or structures of glass fibers or carbon fibers can be employed but also other fiber materials can be used. The fiber materials can be braided, weft-knitted or warp-knitted, woven, or in other ways combined to sufficiently strong structures for the intended manufacturing and application purposes.

A reason for employing fiber-reinforced composites is their comparatively high strength combined with a low specific weight or density. In order to keep the weight as low as possible, care must be taken when manufacturing the fiber-reinforced composite components that not too much matrix material flows into the mold in relation to the employed fiber material. Moreover, the fiber volume contents is decisive for the future mechanical properties of the component. In a finished fiber-reinforced composite component, a defined fiber volume contents is considered optimal. Depending on the component or the employed materials, often a fiber volume contents of 55-60% of the volume of the finished component is considered appropriate.

The inflow of the matrix material is usually controlled by a person and manually controlled; this requires a lot of personnel and also makes the process susceptible to errors so that there is the additional problem that mass production of the components leads to components with great weight fluctuations and quality fluctuations, which is unacceptable for industrial applications.

### SUMMARY OF THE INVENTION

It is therefore an object of the present invention to provide a device of the aforementioned kind in which the inflow of the matrix materials is limited as precisely as possible to a quantity with which the desired fiber volume contents is simply and reliably achieved.

In accordance with the present invention, this is achieved in that a sensor is connected to the inflow connector and/or the resin container with which the actual pressure existing in the inflow connector or the resin container can be measured, wherein the sensor is connected with an actuator that is associated with a closure element, wherein the closure element, when the sensor emits a trigger signal, is movable from an open position into a closed position by means of the actuator, and wherein the closure element blocks or closes off the inflow connector and/or the resin container.

The pressure-dependently controlled closure of the inflow connector is based on the recognition that certain pressure values in the inflow connector or the resin container during inflow of the matrix material into the mold chamber indicate a defined fiber volume contents of the fiber-reinforced composite component that is to be produced, wherein the pressure values in this context always mean underpressure relative to the ambient pressure. In the normal uncontrolled working process of the device, a high underpressure is first generated in the mold chamber by removing the gas contained in the mold chamber by suction via the suction connector with a vacuum pump. Accordingly, vacuum is produced. As a result of the vacuum in the mold chamber and the pressure which is acting on the matrix material in the resin container, the matrix material is sucked or pressed through the inflow connector from the resin container into the mold chamber. The matrix material flows into the mold chamber until in the conveying stretch between the resin container and the mold chamber a pressure compensation relative to the ambient pressure has occurred wherein the pressure compensation also encompasses the flow resistance of the matrix material as a component of the force equilibrium. This applies even when in the suction connector a vacuum or underpressure is still existing because the matrix material cannot overcome the blocking membrane to the gas suction passage.

When in the mold chamber and in the suction connector that is open toward the resin container the force equilibrium is achieved relative to the ambient pressure, there is already more matrix material present in the mold chamber than actually required. This effect is related to the rebound forces of the fibers. In a vacuum, the fibers of the fiber material are resting flat within the mold chamber. When however matrix material flows into the mold chamber and the underpressure is lowered, the fibers of the fiber material will rebound into an erect position. Accordingly, the space volume of the fiber material will increase. In this state, the fibers can then absorb more matrix material between them in comparison to fibers that are lying flat. When the inflow of matrix material into the mold chamber is not interrupted before a force equilibrium relative to the ambient pressure is produced, more matrix material flows into the mold chamber then is required for actual embedding of the same fiber quantity in the matrix material; this causes an increased weight and worsened mechanical properties of the finished component. Since rebounding of the fibers of the fiber material into an erect position depends on the respective underpressure in the mold chamber, the pressure value is a suitable criterion for interrupting the inflow of matrix material as a function of the pressure. By setting an identical pressure value, a high repetition precision and thus uniform product quality can be achieved.

The sensor can be of any suitable type. It can be a mechanical sensor, for example, a simple pressure spring; an electronic sensor, for example, with a piezo crystal as a signal transducer; a hydraulic or pneumatic sensor, for example, embodied as a piston cylinder. The sensor must not measure absolute pressure values; it is also possible to design the sensors such that it measures only relative pressure values. It is advantageous to determine the relevant pressure value that is relevant for rebounding of the fibers into the erect position based on the pressure conditions in the inflow to the mold chamber, in particular the actual pressure in the resin container or, even more advantageous, across the extension or length of the inflow connector. A pressure that is determined therein is usable more reliably than a pressure that is determined, for example, in the mold chamber because the pressure values can vary greatly in the mold chamber depending on the flow behavior and distribution of the matrix material and the respective underpressure at the suction connector. In the resin container undesirable effects can result from the ambient pressure that is acting on the matrix material; these effects falsify the respective measured values.

According to the invention, the sensor is connected to an actuator. The actual pressure value that is measured by the sensor is transmitted to the actuator. The actuator can itself be operated mechanically, electrically, electronically, hydraulically or pneumatically. When the sensor value corresponds to a value at which the closure element is to be closed, the actuator moves the closure element into the closed position. In the closed position the closure element blocks the inflow connector so that no further matrix material can reach the mold chamber. The closure device can be, for example, in the form of a closeable valve in which a movable closing element in the closed position blocks the flow of the matrix material.

According to one embodiment of the invention, the trigger signal activates the actuator for closing the closure element at an actual differential pressure between the actual pressure at the measuring location and the ambient pressure; the differential pressure is between 120 mbar and 200 mbar, preferably between 130 mbar and 170 mbar. When the sensor at these pressure values generates a trigger signal and the closure element is moved by the actuator into the closed position, the flow of matrix material is stopped at a point in time at which already a sufficient fiber volume contents in the fiber-reinforced composite component to be produced has been adjusted and a further inflow of matrix material no longer provides any technical advantages. The precise target value is in particular also depending on the employed type of fiber and the respective component to be produced and the demanded technical specifications of the component to be produced.

According to one embodiment of the invention, the value at which the trigger signal activates the actuator for closing the closure element is designed to be adjustable. By providing adjustability of the value for the trigger signal, the device can be adapted to various components and fiber types. The required adjusting technology can be selected depending on the employed drive technology of the actuator. For a mechanical drive technology, for example, a mechanical adjusting technology is suitable, for an electrical drive technology an electrical or electronic adjusting technology is appropriate. It is however also possible to employ for a mechanical drive technology an electronic adjusting technology or to use other technically possible combinations.

According to one embodiment of the invention, the functions of the sensor, of the closure element, and of the actuator are fulfilled by a spring force-actuated ball seat valve that is mounted in the inflow connector and/or the resin container. The ball seat valve as a mechanical component has a high operational safety, requires little maintenance, has a high repetition precision, and incurs only minimal costs. The ball seat valve which is mounted in the inflow connector allows the matrix material to flow from the resin container into the mold chamber at a pressure differential between the ambient pressure and the underpressure in the inflow connector that is greater than the spring force of the valve spring while it closes the valve with the ball due to the spring force as soon as the pressure differential corresponds to the spring force. By means of the spring force of the valve spring, the trigger threshold of the ball seat valve can thus be precisely adjusted.

It is expressly noted that the afore described embodiments of the invention taken alone but also in any combination may be combined with each other inasmuch as no technical obstacles are encountered.

Further modifications and embodiments of the invention can be taken from the following description and the drawings.

### BRIEF DESCRIPTION OF THE DRAWING

FIG. 1 shows a device according to the invention in which under the cover film two chambers are formed, i.e., the mold chamber and the gas suction chamber separated by a membrane element from the mold chamber, wherein the inflow connector can be blocked or closed off by a closure element that can be closed by an actuator.

FIG. 2 shows a device according to the invention in which under the cover film only the mold chamber is formed and into the mold chamber a suction hose is placed that is enveloped by a membrane film, wherein the inflow connector can be blocked or closed off by a closure element that can be closed by an actuator.

### DESCRIPTION OF THE PREFERRED EMBODIMENTS

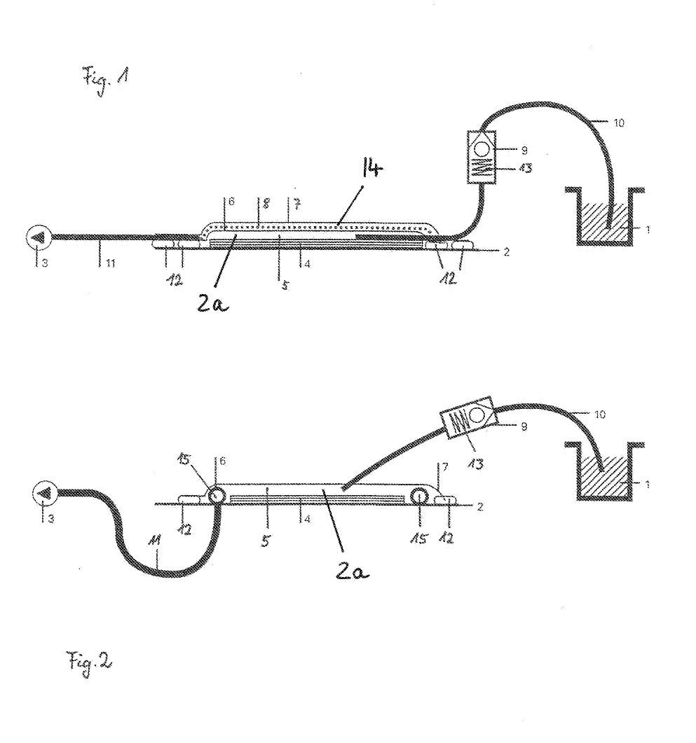

FIG. 1 discloses a device according to the invention in which a matrix material flows into the mold 2 from the resin container 1. The matrix material is sucked by means of a vacuum pump 3 from the resin container 1 into the mold chamber 2a into which, prior to this, fiber material 4 has been placed that is then impregnated with the matrix material 5 which is pumped from the resin container 1. In the illustration of FIG. 1, the fiber material 4 and the matrix material 5 are illustrated in a simplified form as two layered materials. In reality, the matrix material 5 penetrates into the fiber material 4 so that a fiber-reinforced composite component is produced therefrom in the mold 2.

The mold chamber 2a is sealed relative to gas that is exterior to the mold 2 by an airtight cover film 7, i.e., is sealed in particular relative to air. At the edges of the mold 2 the cover film 7 in the illustrated embodiment is additionally sealed by one or several seal strips 12.

In order to be able to remove by suction the gas that is contained in the mold chamber 2a, between the mold chamber 2a and the cover film 7 a membrane element 6 is provided that is gas-permeable but through which the matrix material 5 cannot pass. In order to prevent that the surface of the membrane element 6 that is facing away from the mold chamber 2a will cling to the inner surface of the cover film 7 that is facing the mold chamber 2a and thereby will block the gas suction passage, a nonwoven 8 is inserted between the membrane element 6 and the cover film 7; the gas that is removed by suction from the mold chamber 2a through the membrane element 6 can flow through the nonwoven 8 into the suction connector 11. The membrane element 6 and the cover film 7 together with the nonwoven 8 form a gas suction chamber 14 that extends across the surface area of the mold chamber 2a.

Since the membrane element 6 blocks relative to the matrix material 5 and the mold chamber 2a is covered by the membrane element 6, it is possible to remove by suction all of the gas that is contained in the mold chamber 2a and to produce in the suction area a vacuum by means of which the matrix material 5 that is flowing in from the resin container 1 into the mold chamber 2a is practically distributed in the entire space of the mold chamber 2a so as to be free of any bubbles or gas entrapment.

Because of the vacuum that is produced by the vacuum pump 3, the maximum quantity of matrix material 5 that can be received in the mold chamber 2a is removed by suction from the resin container 1 through the inflow connector 10 and passed into the mold chamber 2a. In this context, more matrix material 5 can reach the mold chamber 2a than is required actually for complete impregnation or wetting of the fiber material 4 in the mold chamber 2a.

In the embodiment illustrated in FIG. 1, a closure element 9 is arranged in the inflow connector 10 in order to limit the inflow of the matrix material 5. In this embodiment, the closure element 9 is a ball 9 of a ball seat valve. In the ball seat valve, the ball 9 is secured and pushed against its seat by the spring force generated by a spring acting as an actuator 13 opposite to the flow direction of the matrix material 5. In this context, the closure element 9 is pulled into an open position when the vacuum that is generated by the vacuum pump 3 is stronger than the spring force that is generated by the spring of the actuator 13. When, taking into consideration the flow resistance, a force equilibrium is generated between the vacuum generated by the vacuum pump 3 and the spring force that is produced by the spring, the spring as an actuator 13 moves the ball as a closure element 9 into its ball seat so that flow of the matrix material 5 through the ball seat valve is shut off.

In deviation from the above described embodiment, it is also possible that , instead of arranging the closure element 9 along the length of the inflow connector 10, the resin container 1 is sealed relative to ambient air so that upon activated vacuum pump 3 a vacuum is produced also in the resin container 1. The inflow of matrix material 5 into the mold chamber 2a can then be regulated in that the resin container 1 is connected with a gas valve that enables inflow of gas into the resin container 1 wherein however the actual pressure that is existing in the resin container 1 is measured by a sensor and the gas valve is provided with a closure element so that the inflow of gas into the resin container can be shut off by an actuator upon receiving a trigger signal of the sensor.

In the illustrated embodiment, the spring as an actuator 13 is at the same time the sensor with which the actual pressure measured in the inflow connector 10 or the resin container 1 is measured. Instead of providing the spring as a sensor, other sensor types can be employed also with which the actual pressure that is present in the inflow connector 10 or the resin container 1 can be measured. The spring as an actuator 13 provides an inexpensive mechanical embodiment of a drive of an actuator 13; however, instead of a mechanical spring, other drives such as solenoids, electric motors, pneumatic or hydraulic motors or the like can be employed also.

The spring that is employed in the illustrated embodiment has a spring characteristic based on which a resulting force corresponding to a deformation travel can be determined. Upon slightly tensioned mounting of the spring in the ball seat valve, wherein the spring is already compressed across a portion of its spring travel by the ball, the spring exerts already a force, corresponding to the specific spring characteristic of the spring, onto the ball with which the ball is secured in the ball seat in the closed position. This force which is exerted in the closed position by the spring onto the ball is the threshold value at which the inflow connector 10 is blocked for flow of matrix material 5. When the vacuum that is generated by the vacuum pump and the suction force that is accordingly exerted onto the matrix material 5 drop below this closure force of the spring, then this constitutes the trigger signal of the spring to move the ball with the spring force into the closed position and to thereby block the inflow connector 10.

FIG. 2 shows an alternative embodiment of the device according to the invention in which under the cover film 7 only the mold chamber 2a is formed and a vacuum hose 15 is placed into the mold chamber 2a, wherein the suction hose 15 is enveloped by a membrane film 6. By enveloping the suction hose 15 with the membrane element 6, the matrix material 5 cannot pass into the suction hose 15. Since the suction hose 15 is connected with the suction connector 11, the gas which is contained in the mold chamber 2a can be removed by suction through the membrane element 6 and through the suction hose 15 via the vacuum pump 3. Depending on how the suction hose 15 is positioned within the mold chamber 2a, it is also possible to evacuate the gas completely from mold chamber 2a with the suction hose 15 and to thereby convey the matrix material 5 free of bubbles into the mold chamber 2a.

Depending on which threshold value is adjusted for the spring force of the spring with which the ball is secured in its closed position in the ball seat, the inflow of the matrix material 5 into the mold chamber 2a is stopped earlier or later. The threshold value as a trigger signal for closing the inflow connector 10 or the resin container 1 should be selected such that in the mold chamber 2a in any case a complete wetting and satisfactory impregnation of the fiber material 4 with the matrix material 5 results.

The invention is not limited to the afore described embodiments. A person of skill in the art is capable of modifying the invention in a suitable way in order to adapt the invention to concrete applications.

The specification incorporates by reference the entire disclosure of German priority document 10 2013 002 551.6 having a filing date of Feb. 15, 2013.

While specific embodiments of the invention have been shown and described in detail to illustrate the inventive principles, it will be understood that the invention may be embodied otherwise without departing from such principles.

What is claimed is:

1. A device for producing components of fiber-reinforced composite, the device comprising:
a mold comprising an airtightly closeable mold chamber adapted to receive and form a composite of a fiber material and a matrix material;
a membrane element disposed in the mold and separating the fiber material and the matrix material from a gas suction passage;
a suction connector connected to the mold and adapted to remove by suction a gas contained in the mold chamber via the gas suction passage;
a resin container;
an inflow connector connected to the resin container and to the mold chamber, wherein the matrix material flows from the resin container into the mold chamber through the inflow connector;
a sensor provided on the inflow connector and/or the resin connector, wherein the sensor measures at a measuring location an actual pressure that is existing in the inflow connector or the resin connector;
a closure element;
an actuator operatively connected to the closure element;
wherein the sensor is connected to the actuator;
wherein the actuator moves the closure element, when activated by a trigger signal emitted by the sensor, from an open position into a closed position and wherein the closure element in the closed position closes off the inflow connector and/or the resin container relative to the mold chamber.

2. The device according to claim 1, wherein the sensor emits the trigger signal when an actual differential pressure between the actual pressure at the measuring location and ambient pressure is between 120 mbar and 200 mbar.

3. The device according to claim 2, wherein the actual differential pressure is between 130 mbar and 170 mbar.

4. The device according to claim 1, wherein a value at which the sensor emits the trigger signal is adjustable.

5. The device according to claim 1, wherein the sensor, the closure element, and the actuator are embodied by a spring force-actuated ball seat valve that is mounted in the inflow connector and/or the resin container.
